(19) United States
(12) Patent Application Publication
(10) Pub. No.: US 2011/0158057 A1
(43) Pub. Date: Jun. 30, 2011

(54) MAGNETIC DISPLAY FOR WATCHES

(76) Inventors: Donald R. Brewer, Long Beach, CA (US); Andrew M. Wright, Costa Mesa, CA (US); David B. Cope, Medfield, MA (US)

(21) Appl. No.: 12/891,453

(22) Filed: Sep. 27, 2010

Related U.S. Application Data
(63) Continuation of application No. PCT/US2009/002066, filed on Apr. 2, 2009.

(51) Int. Cl. G04C 17/00; G09G 3/00

(52) U.S. Cl. 368/239; 345/30

(57) ABSTRACT

A smaller sized flip dot display utilizes a magnetically actuated segment that rotates between two orientations. The orientations display two different optical states. There are disclosed various designs implementing magnetic actuators in conjunction with one or more of microcontrollers, capacitors, balanced flippers, sequentially driven flippers and other features to reduce power consumption of small mobile devices such as watches.

### CROSS-REFERENCE TO RELATED APPLICATIONS

This application is a continuation application of and claims priority to PCT Application Serial No. PCT/US2009/002066 filed 2 Apr. 2009 (International Publication Number WO 2009/126221), and claims priority and the benefit of U.S. Provisional Patent Application No. 61/042,925 entitled “Magnetic Display For Watches” filed 7 Apr. 2008, and also claims priority to and the benefit of U.S. Provisional Patent Application No. 61/043,601 entitled “Magnetic Display For Watches With Ball Elements” filed 9 Apr. 2008, and also claims priority to and the benefit of U.S. Provisional Patent Application No. 61/204,590 entitled “Magnetic Display For Watches” filed 8 Jan. 2009, and further claims priority to and the benefit of U.S. Provisional Patent Application No. 61/162,645 entitled “Magnetic Display For Watches” filed 23 Mar. 2009, each of which is hereby incorporated by reference in its entirety.

### BACKGROUND OF THE INVENTION

Large scale flip dot displays are operated utilizing a matrix of rotatable pixels, each pixel having a permanent magnet. Current passes through an underlying electromagnet and generates a magnetic field that rotates the pixel up to 180 degrees to display one of two sides. Disadvantages of this type of display technology have prevented its usage much beyond large, outdoor signage. For example, flip dot displays require high voltage to actuate rotation of a pixel, usually not less than 18-32 volts with corresponding significant current consumption. Flip dot displays are also quite expensive per pixel, and have only been commercialized in very large segment sizes. Due to these power, size, and cost limitations the prior art and industrial applications of flip dot displays have focused solely on large, outdoor signage applications. Furthermore, present flip dot displays typically have a standard industrial look featuring a green, yellow, or white painted coating one side of the pixel representing its “ON” optical state. The “ON” optical state has a high contrast and visibility against the matte black painted background or opposing side of the pixel representing the “OFF” optical state.

### SUMMARY OF THE INVENTION

In one embodiment there is a watch display comprising a plurality of rotatable segments and a background. Each segment includes a magnetic material extending across its width and is rotatable between at least two optical states. The watch display further comprises a plurality of magnetic actuators positioned beneath the plurality of segments to rotate the segments between the at least two optical states. Each magnetic actuator includes a U-shaped core having two arms with coils thereon and has a top defined by a pair of ends of the two arms. The top is substantially parallel or below a plane defined along the width of the magnetic material of the corresponding segment. The top at the two arms extends toward the magnetic material of the segment.

In one refinement there is a microcontroller for controlling rotation of the plurality of segments that is connected to the plurality of magnetic actuators.

In another refinement the microcontroller is programmed to sequentially rotate the plurality of segments.

In another refinement there is a battery electrically connected to the microcontroller. The microcontroller directly drives the coils of each magnetic actuator.

In another refinement the magnetic actuators are integrated onto a printed circuit board, and further includes an adhesive around the cores.

In another refinement there is means for detecting impact that is connected to the microcontroller. The microcontroller is programmed to rotate each segment to a correct optical state when an impact exceeding a preset limit is detected.

In another refinement there is a capacitor electrically connected in parallel with the battery that supply a DC-DC voltage converter.

In another refinement there is a capacitor is connected in parallel with the battery that supplies the DC-DC voltage converter. The voltage signal from the DC-DC converter goes through a switching circuit that selects the voltage level to supply the microcontroller. The microcontroller is supplied with either two voltage levels, one voltage level directly from the battery and the other voltage level from the output of the DC-DC voltage converter.

In another refinement there is a battery electrically connected to a microcontroller for controlling rotation of the plurality of segments that is connected to the plurality of magnetic actuators. The microcontroller directly drives the coils of each magnetic actuator. The segments are ball segments.

In another embodiment there is a timepiece display module comprising a display having a plurality of rotatable segments that provide chronological or graphical information. Each rotatable segment includes a magnetic portion and rotates between a first orientation having a first optical state and a second orientation having a second optical state that is different from the first optical state. At least some of the segments are adjacent to a background that substantially matches one of the first optical state and the second optical state. The module further includes a battery electrically connected to means for sequentially magnetically rotating the plurality of rotatable segments.

In one refinement there are means for sequentially magnetically rotating the plurality of rotatable segments that includes a microcontroller for controlling rotation of the plurality of segments that is connected to a plurality of magnetic actuators. The microcontroller is electrically connected to the battery.

In another refinement the microcontroller directly drives the magnetic actuators.

In another refinement the magnetic actuators are integrated onto a printed circuit board. Each magnetic actuator includes a core and at least one coil and further including an adhesive around the cores.

In another refinement there is a means for detecting impact that is connected to the microcontroller, the microcontroller being programmed to rotate each segment to a correct optical state when an impact exceeding a preset limit is detected.

In another refinement the means for detecting impact is a piezo shock sensor.

In another refinement there is a capacitor electrically connected to the microcontroller in parallel to the battery.

In another refinement there is a DC-DC voltage converter.

In another refinement the segments include a simulated dot matrix pattern.

In another refinement there is at least one analog hand.

In another refinement at least one of the segments is nonlinear.

In another refinement each rotatable segment is a ball segment sandwiched between a top substrate and a bottom substrate.

In another embodiment there is a watch flip dot display comprising a plurality of magnetic actuators that rotate a plurality of at least partially magnetic rotatable segments. The segments collectively represent at least one alphanumeric digit in a background when oriented at one of a first rotational position and a second rotational position. The plurality of magnetic actuators are sequentially directly driven by a microcontroller that is electrically connected to a battery.

In one refinement each rotatable segment is a ball segment sandwiched between a bottom substrate and a substantially transparent cover.

In another refinement the substrate is made of polyphenylene sulfide.

In another refinement at least one of the rotatable segments is nonlinear.

In another refinement there is a capacitor. The microcontroller is electrically connected in parallel to the capacitor and to the battery. The battery is a coin cell battery.

In another refinement at least one of the rotatable segments comprises at least two simulated dot matrix panels.

In another refinement only a portion of each segment is magnetic. Each magnetic portion of the segment is weight balanced with respect to an axis of rotation of the segment.

In another refinement each magnetic actuator includes a U-shaped core defined by a base portion connecting a first arm and a second arm. The first arm includes a first coil and the second arm includes a second coil.

In another refinement each rotatable segment has a magnetic portion that extends across an entire width of the segment.

In another refinement a top of each arm is positioned at or slightly below a plane defined by the segment, and the top of each arm extends toward the magnetic portion.

In another refinement at least two coils and one core are integrated onto a bobbin. An adhesive is applied to provide structural integrity to the coil connections and core material.

In another refinement each rotatable segment is a ball segment sandwiched between a top substrate and a bottom substrate.

In another refinement each magnetic actuator is a single post and a single coil, and the display is a curved display.

In another refinement the magnetic actuators are integrated onto a printed circuit board, and further includes an adhesive around the cores.

In another refinement there is a means for detecting impact that is connected to the microcontroller. The microcontroller is programmed to rotate each segment to a correct rotational position when an impact exceeding a preset limit is detected.

In another refinement the means for detecting impact is a piezo shock sensor.

In another refinement there is a DC-DC voltage converter. The battery is a coin cell battery.

In another refinement there is at least one analog hand positioned above the rotatable segments and the background.

In another embodiment there is a watch comprising a display including a plurality of rotatable segments that collectively provide chronological information in a background. Each rotatable segment includes a magnetic portion and rotates between a first orientation to present a first display face with a first optical state and a second orientation to present a second display face having a second optical state. The first optical state is different from the second optical state. One of the first optical state or the second optical state substantially matches the background. The watch further comprises means for magnetically rotating the plurality of rotatable segments. The watch also includes a microcontroller that directly drives the means for magnetically rotating the plurality of rotatable segments. The watch further includes a battery electrically connected to the microcontroller.

In one refinement the means for magnetically rotating the plurality of segments includes a plurality of magnetic actuators positioned beneath the plurality of segments to rotate the segments between the first and second optical states. Each magnetic actuator includes a U-shaped core having two arms with coils thereon and having a top defined by a pair of ends of the two arms. The top is substantially parallel or below a plane defined along a width of the magnetic portion of the corresponding segment. Adjacent the top the two arms extend toward the magnetic portion of the segment.

In another refinement the microcontroller is programmed to sequentially drive the coils in a particular pattern.

In another refinement at least some of the segments include a plurality of simulated dot matrix panels.

In another refinement the magnetic portion of each segment is inertially balanced with respect to the axis of rotation of the segment.

In another refinement at least one of the display faces of at least one of the plurality of rotatable segments includes an attached material selected from the group consisting of rhinestone, crystal, diamond, gemstone, or metal.

In another refinement there is a means for detecting impact that is connected to the microcontroller. The microcontroller is programmed to rotate each segment to a correct optical state when an impact exceeding a preset limit is detected.

In another refinement the microcontroller is programmed to sequentially rotate the plurality of segments.

In another refinement there is a means for detecting impact that is connected to the microcontroller. The microcontroller is programmed to rotate each segment to a correct optical state when an impact exceeding a preset limit is detected.

In another refinement there is a capacitor electrically connected in parallel with the battery that supply a DC-DC voltage converter.

In another refinement the capacitor is connected in parallel with the battery that supplies the DC-DC voltage converter. The voltage signal from the DC-DC converter goes through a switching circuit that selects the voltage level to supply the microcontroller. The microcontroller is supplied with either two voltage levels, one voltage level directly from the battery and the other voltage level from the output of the DC-DC voltage converter.

In another refinement there is a means for detecting impact is a piezo shock sensor and a DC-DC converter to raise the voltage from the battery. The battery is a coin cell battery.

In another refinement the plurality of rotatable segments are a plurality of ball segments sandwiched between a bottom substrate and a substantially transparent cover.

In another embodiment there is a mobile device comprising a display having a plurality of rotatable segments that provide chronological or graphical information in a background. Each rotatable segment includes a magnetic portion and rotates between a first orientation having a first optical state and a second orientation having a second optical state that is different from the first optical state. The background has an optical characteristic that substantially matches one of the first optical state and the second optical state of a majority of the segments. A microcontroller is electrically connected to a plurality of magnetic actuators that are positioned beneath the plurality of rotatable segments. The microcontroller is programmed to rotate each segment to a correct optical state when an impact exceeding a preset limit is detected by means for detecting impact that is connected to the microcontroller. The mobile device further includes a battery electrically connected to the microcontroller.

In one refinement the mobile device is selected from the group consisting of a watch, clock, jewelry, cell phone, or carrying case for a cell phone or MP3 player.

In another refinement at least one of the rotatable segments includes at least two simulated dot matrix panels.

In another refinement the magnetic portion of each segment is weight balanced with respect to an axis of rotation of the segment.

In another refinement the microcontroller is programmed to sequentially rotate the plurality of segments.

In another refinement the microcontroller directly drives the plurality of magnetic actuators.

In another refinement the magnetic portion of each segment extends across an entire width of the segment.

In another refinement the device is a watch. The watch further comprises a capacitor electrically connected in parallel with the battery that supply a DC-DC voltage converter. The battery is a coin cell battery.

In another refinement the device is a watch. The watch further comprises a capacitor is connected in parallel with the battery that supplies the DC-DC voltage converter. The voltage signal from the DC-DC converter goes through a switching circuit that selects the voltage level to supply the microcontroller. The microcontroller is supplied with either two voltage levels, one voltage level directly from the battery and the other voltage level from the output of the DC-DC voltage converter. The battery is a coin cell battery.

In another refinement at least one of the rotatable segments includes a display face having an attached material selected from the group consisting of a diamond, crystal, gemstone, or metal.

In another refinement the device is a watch and the means for detecting impact is a piezo shock sensor and the battery is a coin cell battery. The watch further includes a DC-DC voltage converter connected to the coin cell battery.

In another refinement the plurality of rotatable segments is a plurality of ball segments sandwiched between a top substrate and a bottom substrate.

In another embodiment there is a watch comprising a plurality of rotatable segments that provide at least one of chronological or graphical information in a background. Each rotatable segment includes a magnetic portion and rotates between a first orientation having a first optical state and a second orientation having a second optical state. The background substantially matches one of the first optical state and the second optical state. The watch further includes means for magnetically rotating the plurality of rotatable segments. The means for magnetically rotating is controlled by a microcontroller that is electrically connected in parallel to a coin cell battery and a capacitor.

In one refinement the microcontroller is programmed to sequentially rotate the plurality of segments.

In another refinement the microcontroller directly drives the means for magnetically rotating.

In another refinement there is a means for detecting impact that is connected to the microcontroller. The microcontroller is programmed to rotate each segment to a correct optical state when an impact exceeding a preset limit is detected.

In another refinement the device is a watch. The watch further comprises a capacitor is connected in parallel with the battery that supplies the DC-DC voltage converter. The voltage signal from the DC-DC converter goes through a switching circuit that selects the voltage level to supply the microcontroller. The microcontroller is supplied with either two voltage levels, one voltage level directly from the battery and the other voltage level from the output of the DC-DC voltage converter. In another refinement the plurality of segments is a plurality of ball segments.

In another embodiment there is a timepiece display module comprising a plurality of at least partially magnetic rotatable polychromal ball segments positioned within a plurality of cavities defined at least in part by a bottom substrate. The plurality of segments are arranged to display chronological information within a background of an upper surface of a top substrate. The background has an optical characteristic substantially matching one of at least two different optical states of the segments. The timepiece display module further comprises a plurality of magnetic actuators for rotating the plurality of segments. The magnetic actuators are positioned beneath the bottom substrate. The timepiece display module also comprises a microcontroller electrically connected to the magnetic actuators for controlling rotation of the ball segments. The timepiece display module further includes a battery electrically connected to the microcontroller.

In one refinement the ball segments are bichromal.

In another refinement the ball segments are cylindrically shaped.

In another refinement the ball segments are spherically shaped.

In another refinement each magnetic actuator is a single post with a coil thereon.

In another refinement there is an adhesive around the post.

In another refinement there is a plurality of non-rotating segments in the plurality of cavities. The non-rotating segments substantially match the optical characteristic of the background.

In another refinement there is a means to detect impact that is electrically connected to the microcontroller.

In another refinement there is a DC-DC converter to raise the voltage from the battery. The battery is a coin cell battery.

In another refinement there is a means to detect impact that is electrically connected to the microcontroller. The microcontroller is programmed to sequentially drive the coils for respective segments when an impact exceeding a preset limit is detected.

In another refinement the microcontroller is programmed to sequentially rotate the plurality of segments.

In another refinement the microcontroller directly drives the magnetic actuators.

In another refinement the magnetic actuators are integrated onto a printed circuit board.

In another refinement there is a piezo shock sensor that is connected to the microcontroller. The microcontroller is programmed to rotate each segment to a correct optical state when an impact exceeding a preset limit is detected.

In another refinement there is a capacitor electrically connected to the microcontroller in parallel to the battery.

In another refinement there is at least one analog hand.

In another refinement the upper surface of the top substrate is curved. Multiple embodiments are disclosed and claimed herein. There are numerous refinements that are generally applicable to most, if not all, of these embodiments.

### BRIEF DESCRIPTION OF THE FIGURES

FIG. 1 is a side view of a single magnetically actuated segment.

FIG. 2 is a top view of FIG. 1.

FIG. 3 is a side view of the embodiment of FIG. 1 illustrating a single rotating pixel integrated in the same plane as the surrounding background.

FIG. 4 is a side view of an embodiment of a single magnetic actuator and segment depicting the “OFF” state.

FIG. 5 is a side view of an embodiment of a single magnetic actuator and segment depicting the “ON” state.

FIG. 6 is a side view of another embodiment of a single magnetically actuated segment depicting the “OFF” state.

FIG. 7 is a top view of FIG. 6.

FIG. 8 illustrates an embodiment of a coil and core bobbin.

FIG. 9 illustrates the embodiment of FIG. 8 when integrated onto a printed circuit board.

FIG. 10 illustrates one embodiment of the top and bottbm panel designs.

FIGS. 11-12 illustrate an embodiment of a rotatable segment that allows non-linear segments to be displayed.

FIG. 13 illustrates a schematic of a circuit driving the magnetic display.

FIG. 14 illustrates the circuit diagram for a shock sensor portion of the circuit.

FIG. 15 is a side view of a magnetic display having one or more rotating ball segments.

FIG. 16 is a side view of another embodiment of a rotating ball segment.

FIG. 17 is a side view of yet another embodiment of a rotating ball segment.

FIG. 18 is a top view of a magnetic display having one or more rotating ball segments.

FIG. 19 is a side view of a curved magnetic display including rotating ball segments.

### DETAILED DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

There is an unmet need for the application of a magnetic flip dot display in smaller scale consumer products that typically have only small batteries available for power. The contrasting sides of each rotatable segment utilize one or some combination of contrasting colors, surface textures, and/or affixed materials. It is contemplated as within the scope of the invention that the flip dot displays disclosed herein could be used in watches, clocks, mobile phone primary or secondary display, as well as other mobile or smaller sized products, such as jewelry.

The term flip dot display as used herein describes a rotatable pixel or segment with at least a first display orientation and a second display orientation, actuated by an underlying actuation element to display one of the display orientations. Some of the embodiments discussed herein preferably include a top face and a bottom face with 180° rotation between the two surfaces. The actuation element is preferably, for example, one or more coils of wire, or one or more coils around a core material, such as a ferromagnetic ceramic or steel laminate. It should also be understood that all of the flip dot display embodiments disclosed herein refer to a rotatable pixel or segment changing between at least two possible optical states. When actuation force is generated (preferably magnetically) the rotatable pixel will rotate to display either an “ON” optical state or an “OFF” optical state. In the “ON” optical state the color, texture and/or material composition attached to the surface of the pixel or segment differs from the surrounding background. An “OFF” optical state occurs when the color, texture, and/or material composition on the opposing side of the pixel or segment substantially matches that of the surrounding background. The surrounding background is understood to refer to a non-changeable surface. The surrounding background around each rotatable pixel or segment is preferably, but not necessarily, in approximately the same plane as the display surface of the rotatable pixel or segment.

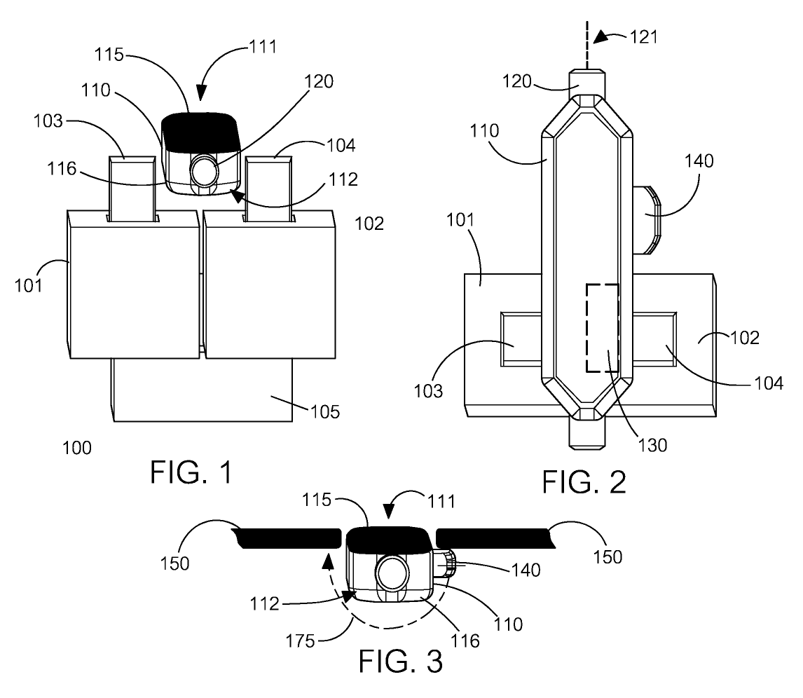

FIG. 1 illustrates aspects of a single magnetic actuator. U-shaped core 106 has two armatures 103 and 104 connected by base portion 105. U-shaped core 100 could be constructed out of any ferromagnetic material, such as a ceramic or steel laminates. Two coils 101 and 102 are shown positioned around the two armatures 103 and 104, respectively. Coils 101 and 102 are typically constructed out of copper wire, but may be of any conductive wire material, or conductive deposits on a printed, circuit board (PCB). Although not shown in this figure, the coils 101 and 102 may be driven individually or serially inter-connected, so they can be driven and behave as a single electromagnetic coil. Those of ordinary skill in the art recognize the various means that two coils 101 and 102 could be used to connect them electrically to behave as individual coils or as a single coil. When the coils 101 and 102 are connected serially, and current is then applied in one particular direction, it generates a magnetic force emanating out of the center of the first coil 101. The first coil 101 winding direction and orientation around the core armature 103 is such that current passing through the first coil 101 generates a positive magnetic force (a positive magnetic force being defined as a force that seeks geographical north) emanating out of the top. A negative magnetic force would be generated out of the bottom of the coil 101. The second coil 102 would be oriented so that when current is passing through the second coil 102 it produces a magnetic field in a direction that is opposite to the first coil 101. Thus, a positive magnetic force is generated out of its bottom and a negative magnetic force out of its top. The U-shaped core material effectively increases the magnetic forces generated by the current passing through either one or both coils 101 and 102.

FIG. 1 depicts a rotatable pixel 110 capable of displaying two optical states. “OFF” optical state 111 is illustrated as black in FIG. 1 on face 115. An “ON” optical state 112 is illustrated as white and is located on the bottom face 116 of the rotatable pixel 110. Rotatable pixel 110 could have a wide variety of shapes including round, square, or a rectangular shape as depicted in FIG. 1. The “OFF” and “ON” colors depicted are only representative, and a wide variety of contrasting coatings, paints, or attached materials could be used on either face. Those of ordinary skill in the art will understand how a matrix of rectangular shaped rotating pixels 110 might be used to produce a conventional alpha-numeric digit. Such combinations might find use in watch displays or other alpha-numeric indicators, such as the commonly used seven pixel numeric digit, as well as fourteen and sixteen pixel alphanumeric digits. Rotatable pixel 110 turns on an axle 120 that allows it to rotate (preferably approximately 180 degrees) to display either one of the two optical states defined by the color, material, or texture present on either of two display faces.

Axle 120 is preferably a central shaft used to position the rotating pixel 110 and allow rotation. In some cases the axle 120 may be mounted and fixed, but with a bearing or bushing located inside the rotating pixel 110 to allow the pixel to rotate around the axle 120. Axle 120 could comprise a wire, or plastic or metal rod that is fixed and passes through some portion of the rotating pixel 110 that rotates around the axle 120. Rotating pixel 110 may also be constructed out of a low friction material to more easily rotate about a fixed axle 120. In FIG. 1 the axle 120 is preferably integrally formed with rotating pixel 110, and therefore has mounting points, not shown in this figure, that allow the axle 120 to rotate. The axle 120 for each pixel 110 is preferably mounted to either the underlying module or frame or surrounding background (not shown in FIG. 1). When axle 120 is not fixed, bearings, bushings, or low friction material may be incorporated into the mounting points where the axle 120 is supported. Separate bearing elements or the mounting points themselves could be made out of metal such as steel or brass, or injection molded material that may be made from or coated with some low friction material such as Teflon, or polyoxymethylene (POM). Rotatable pixel 110 has permanent magnet properties incorporated therein, and rotates when the appropriate magnetic force is generated by passing current through the underlying coils 101 and 102. The rotatable pixel 110 can be positioned above or below, but preferably has a display face approximately in the same plane with respect to the top of the two armatures 103 and 104 as shown in FIG. 1.

FIG. 2 shows a top view of an embodiment including a rotatable pixel 110 and underlying magnetic actuator with dual coils 101 and 102 around the two core armatures 103 and 104. A portion of rotatable pixel 110 has a permanent magnet 130, illustrated as a dashed rectangle indicating that that it is incorporated therein. The permanent magnet 130 could be a magnetic thermoplastic or rubber material, ferrite, ceramic, Aluminum Nickel Cobalt (AINiCo), Samarium Cobalt (SmCo), Neodymium Iron Boron (NdFeB), injection molded material, such as Nylon 6 or 12, that contains the desired mixture of magnetic material, or other magnetic materials or rare earth materials that possess a magnetic field. Alternatively, the entire rotatable pixel 110 could be constructed out of a permanent magnet, or the permanent magnet 130 could be found in some portion thereof as depicted in FIG. 2, or multiple portions. As in the embodiment illustrated in FIG. 2, a significant portion of the permanent magnet 130 preferably lies off center, i.e., on one side of the center axle 120 that defines the axis of rotation 121.

Driving coils 101 and 102 preferably do not extend across the entire axial length of the rotating pixel 110, and even more preferably no more than half the axial length. This enables closer placement of rotating pixels 110 in some or all of the small consumer product applications. Those of ordinary skill in the art, however, will understand that the actuation system could extend across the entire axial length of a rotatable pixel 110. FIG. 2 also illustrates a stopping mechanism 140 preferably integrated into the pixel 110. A stopping mechanism is preferably some non-symmetrical component that extends, or some portion that is removed from the rotatable pixel. Stop 140 engages the surrounding frame, background, or extension from the underlying module so as to allow nearly, or as much as, but not typically exceeding, a 180 degree rotation. Stop 140 shown in FIG. 2 is an extension of the rotatable pixel 110, versus a round or square cutout, that is commonly used in flip dot displays today. As shown in FIG. 2, stop 140 is preferably offset along the axial length from the armatures 103, 104 and coils 101, 102.

FIG. 3 illustrates a rotatable pixel 110 in the same plane as the surrounding background 150. Surrounding background 150 is preferably a plane of material that has portions removed in which one or more rotatable pixels 110 are positioned. Background 150 preferably has an immutable visual appearance that closely matches one of the visible states of rotating pixel 110. An “OFF” optical state 111 occurs when the visible state of the rotatable pixel 110 substantially, and ideally as closely as possible, matches that of background 150. An “ON” optical state 112 occurs when the visible state of rotatable pixel 110 differs visibly from the background 150. As illustrated in FIG. 3, the black face 115 of the rotating pixel 110 is in the visible position producing an “OFF” pixel 111 since it closely matches the black appearance of background 150. This is in contrast to the bottom face 116 which is illustrated as white and would be perceived as an “ON” pixel. The white of the “ON” state 112 significantly differs from the background 150 color, when the pixel 110 is magnetically actuated to rotate 180 degrees into this new position.

FIG. 3 also shows a cross-section of the rotatable pixel 110 as its stop 140 engages the bottom of the surrounding background 150 to limit the rotation to approximately 180 degrees. In this particular embodiment a protrusion or extension of the rotatable pixel 110 acts as the stop 140. An arc 175 illustrated as a dashed line indicates the directions of rotation possible from the current position of the rotating pixel 110. The stop 140 then engages the bottom of background 150. Using a stop 140 located beneath the surrounding background 150 provides a better design aesthetic as the rotatable pixels 110 appear symmetrical from the viewer's perspective. Those of ordinary skill can also understand how the stop 140 could also allow rotation in an opposite arc that allows it to be visible, but functions the same.

It is contemplated as within the scope of the invention that rotatable pixel 110 could also have printed text, symbols, or other information. Thus, one pixel 110 by itself conveys desired information. For example, one side of the rotating pixel 110 could have text printed on one side that says AM, and PM printed on the other side. In this scenario either face of the pixel 110 could display detailed information without having to be part of a matrix of pixels that forms an alpha-numeric digit to convey information.

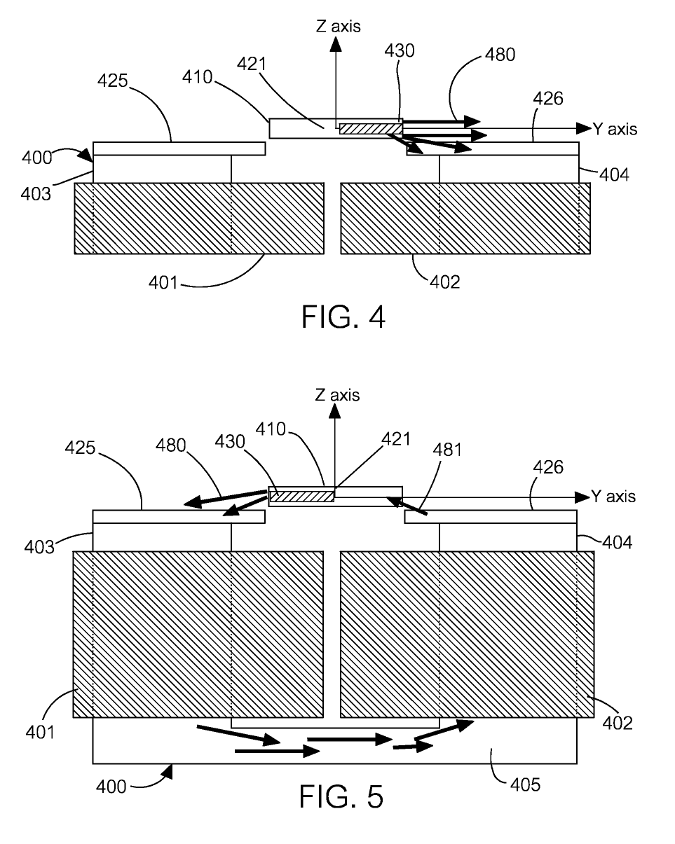

FIG. 4 illustrates the magnetic flux that exists within a cross section of a single rotatable pixel in “OFF” electrical state. FIG. 4 shows a magnified view of the system in an “OFF” electrical state defined as no current passing through any part of the magnetic actuation system. U-shaped core 400, of which only a portion is shown in this figure, preferably has a single driving force from two separate coils 401 and 402 located around each armature 403 and 404. Only a portion of the coils 401 and 402 are depicted, and although not shown in this figure they are preferably connected to the electronic driving circuit and driven serially, and simultaneously. The coils are also preferably arranged with opposite polarity so when driven serially with the same current they will produce magnetic field in opposite directions. A permanent magnet 430 is preferably integrated into at least a portion of rotatable pixel 410 so that at least half of the width of the permanent magnet 430 would be located on one side of the pixel axis of rotation 421. FIG. 4 illustrates an embodiment wherein the majority of the permanent magnet 430 is located to one side of the axis of rotation 421 around which pixel 410 rotates, and is magnetized so that its magnetic fields emanates parallel to its length along the Y-axis. It is also contemplated as within the scope of this invention that the permanent magnet 430 could be magnetized so that its magnetic fields would emanate perpendicular to its length, and still be functional. The resulting magnetic fields of the permanent magnet 430 would then be parallel to the Z axis shown.

FIG. 4 depicts the magnetic force lines that exist in an “OFF” electrical state with no current being driven into either or both coils 401 and 402. Armatures 403 and 404 typically provide enough attractive surface area and magnetic attraction to hold the permanent magnet 430 in place when not in the “ON” electrical state. In some embodiments, however, additional pole plates 425 and 426 may be added. In this “OFF” electrical state the permanent magnet 430 is in close proximity to a first pole plate 426 that has been placed on top of armature 404. Pole plates 425 and 426 are preferably constructed out of magnetic attractive materials such as steel, and can be used to provide a larger surface area for the permanent magnet 430 to be attracted and hold the rotating pixel in a desired orientation. Although not depicted in this figure, armatures 403 and 404 could be located directly underneath, to one side, or even parallel to the plane of the permanent magnet 430 and corresponding rotating pixel 410. Depending on the other system design components there may be certain advantages to having either the top of the armatures 403 and 404 or pole plates 425 and 426, if utilized, directly parallel to the permanent magnet 430. For example, having the top of armatures 403 and 404 or pole plates 425 and 426 in the same horizontal plane as the permanent magnet 415 and corresponding rotatable pixel 410 it resides within (or some portion thereof), may further insure that the matrix of rotating pixels all appear horizontally in line with the surrounding background

In the “OFF” electrical state the strongest magnetic flux lines 480 extend out of the permanent magnet 430, the magnetic poles being oriented along the horizontal or Y-axis as shown. Permanent magnet 430 is attracted to plate 426 as well as underlying armature 404. Thus, when a display is subject to vibration, dropping, or other movement the permanent magnet 430 prevents or minimizes rotation of the pixel 410. Permanent magnet 430 is shown in FIG. 4 as being slightly above the pole plate 426 and armature 404. However, the permanent magnet 430, axis of rotation 421, and the rotating pixel itself 410 could be located in the same plane, or even below the plane of the pole plate 426 or top of the armature 404. Final permanent magnet 430 size and material selection and overall system design must account for the maximum, vibration, drop, or other forces that the system might undergo. System design must also account for the resistance of the coils 401 and 402, and the current required to drive the coils 401 and 402 to generate enough electromagnetic force to rotate the pixel 410 into a different orientation. Proper material selection and system design is particularly important in small consumer product applications such as watches, or mobile phones wherein size and battery life are concerns.

FIG. 5 illustrates the magnetic flux that exists within a cross section of a single actuatable system in the “ON” electrical state. FIG. 5 shows a magnified view of the system in an “ON” electrical state. Current passing through the coils 401 and 402 around core 400 produces a repulsive magnetic force, with respect to the permanent magnet 430 and corresponding rotatable pixel 410. In FIG. 5 the general direction of this repulsive magnetic force 481 is out of top of coil 402, while an attractive magnetic force 480 now emanates out of the top of coil 401. FIG. 5 shows the resulting magnetic flux when “ON” current is still being applied, but the permanent magnet 430 and corresponding rotatable pixel 410 have rotated into the new, desired orientation. The current passed through the coils 401 and 402 must be sufficient to generate a repulsive magnetic force 481 that is greater than the magnetic attractive force 480 that exists between the permanent magnet 430 and either the pole plate 426 or the armature 404 in the “OFF” electrical state. This rotation of the permanent magnet 430 as part of the corresponding pixel 410 can occur in very fast response times ranging from 1 msec-50 msec. In some instances after current has been passed through the coils 401 and 402, and accelerated the permanent magnet 430 and corresponding rotatable pixel 410 toward its new orientation, but before it actually reaches the new orientation, the current could be removed. The main purpose of removing current at some point, possibly after the rotatable pixel 410 is approximately half-way between the two positions, is to reduce power consumption when there is enough momentum to insure that the rotation will be completed. FIG. 5 illustrates current still being driven in the system even though the pixel 410 is in its new optical state. One embodiment involves removing current from the system at some intermediate time during the rotation of the pixel 410 to reduce overall power consumption of the system.

The above description of FIGS. 1-5 substantially tracks that present in U.S. application Ser. No. 11/904,398 to Brewer et al. entitled “Magnetic Display For Watches” that was filed on 27 Sep. 2007 and that published on 10 Apr. 2008 as U.S. Pub. No. 2008/0084381, the contents of which are incorporated herein by reference. That prior application is commonly assigned to the assignee of the present application. Substantially the same disclosure is also present in PCT Application PCT/US2007/20845 that published on 3 Apr. 2008 as No. WO 2008/039511.

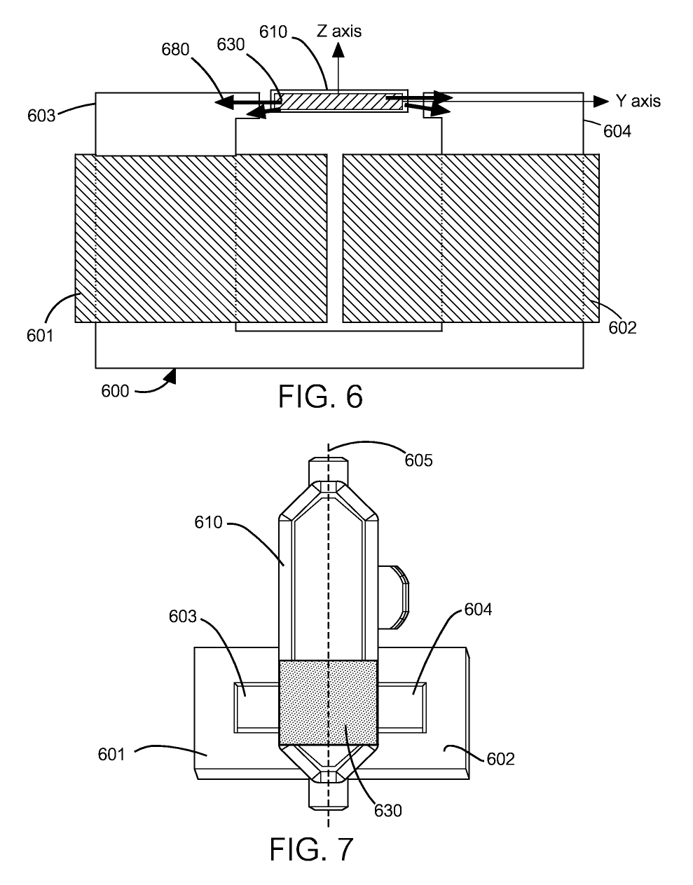

FIG. 6 depicts another embodiment of a single magnetic actuator and segment in the “OFF” electrical state. Similar to the previously discussed embodiments of FIGS. 1-5, coils 601 and 602 are around the U-shaped core 600. However, the armatures 603 and 604 of the U-shaped core 600 extend toward the permanent magnet 630. This reduces the distance between the armatures of the core 603 and 604 and the permanent magnet 630 within the rotatable segment 610. The reduction of this distance increases the holding magnetic strength that maintains the rotatable segment 610 in the desired “ON” or “OFF” optical state. The previously discussed embodiment of FIGS. 1-5 discloses the use of pole plates. However, in small mobile devices the production and assembly of pole plates on top of the tiny armatures of the core 603 and 604 is challenging. The extension of the top of the cores 603 and 604 provides an improved embodiment that is easier to manufacture.

Additionally, as illustrated in FIG. 7, the segment preferably includes a permanent magnet 630 that does not lie entirely on just one half of the rotational axis of the rotatable segment 610. A permanent magnet 630 that extends over some portion on both sides of the center axis might better maintain the rotatable segment 610 in place when an external shock occurs, such as dropping onto a hard surface. A permanent magnet 630 that extends from one side of the rotatable segment 610 to the other will provide additional holding magnetic force as it is attracted to the extended upper portion of the cores 603 and 604. This magnetic attraction is illustrated by the magnetic flux lines 680 of FIG. 6. The upper portion of the cores 603 and 604 should lie in approximately in the same horizontal plane or slightly below the horizontal plane of the rotatable segment 610.

FIG. 7 illustrates a top down view of a permanent magnet 630 that traverses the entire rotatable segment 610. The result is a stronger magnetic holding strength to neighboring cores 603 and 604. Additionally, the rotatable segment 610 should be better inertially balanced. The permanent magnet 630 located therein is shown to be equally shaped and equally weighted on either side of the rotating axis 605. An inertially balanced rotatable segment 610 will be less subject to inertia that may cause it to inadvertently flip when subjected to a shock such as a drop, impact, or vibration. The overall thickness of the rotatable segment 610 is preferably minimized so that the needed gap between the rotatable segments 610 and surrounding background is minimized. The rotatable segment 610 may also feature beveled or rounded corners to further reduce the gap between the rotatable segment 610 and surrounding background by requiring less clearance distance.

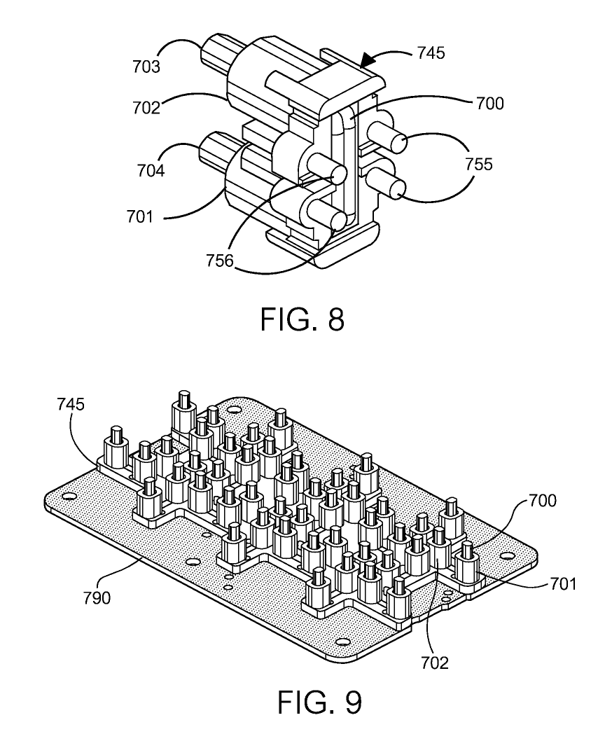

FIG. 8 illustrates an embodiment that provides for easier assembly during manufacture in which the bobbin could preferably be constructed out of a variety of plastics. Coils 701 and 702 are wound around the plastic bobbin 745. Bobbin 745 has two conductive leads 755 and two conductive leads 756. The leads are preferably integral with the bobbin 745. The two conductive leads for each coil 701 and 702 are attached to the respective leads 755, 756. Bobbin 745 thus permits core 700 to then be inserted after completion of the coil windings producing a complete bobbin 745 assembly comprising core 700, and coils 701 and 702 around armatures 703 and 704. In embodiments in which coils 701 and 702 are connected in series, instead of two conductive leads per coil the coils 701 and 702 can be connected in series using just three conductive leads.

FIG. 9 illustrates a variation on the features of FIG. 8 in which the underlying bobbin 745 could be a sub-assembly upon which the coils 701 and 702 and cores 700 for an entire seven segment alphanumeric digit, or even the entire display, as illustrated in FIG. 9, are attached. This promotes ease of manufacture as bobbin 745 sub-assembly may be placed on the printed circuit board and have appropriate connections made to the coils 701 and 702 that must be driven. Such a design enables the small mobile consumer applications contemplated as within the scope of the invention to be produced in sufficient numbers with fewer losses during quality control review. In another variation the leads for the individual coils 701 and 702 are attached to lower portion of the plastic subassembly core holder so that it can be easily attached to the printed circuit board (PCB) 790 it is mounted on. In yet another variation an adhesive (including but not limited to epoxy, glue, or an elastomeric compound) is applied around the coils 701 and 702 and cores 700 arranged on the printed circuit board 790 to strengthen and hold in place the often brittle ferrite cores when subjected to production stress, or vibration or dropping in final consumer product application. The core 700 and coils 701 and 702 encased in an adhesive also secure and hold in place the very thin leads of the coils to reduce the possibility of breakage when a shock such as impact, or drop is encountered.

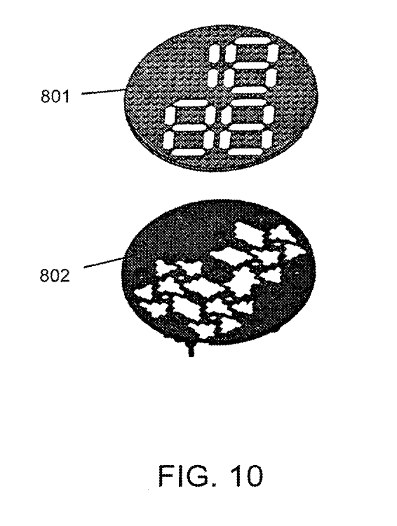

FIG. 10 illustrates an embodiment that includes a top layer 801 and bottom layer 802 that sandwich the rotatable segments 803 between them. Such an embodiment further promotes ease of assembly in mass production. The layers are preferably constructed using materials with sufficient structural integrity so the assembly process itself, and possible over-torquing of screws does not bend the bottom 802 and top 801 layers. The layer materials might include ABS or polycarbonate plastics, or combinations thereof. However, in the more preferred embodiment either or both of the substrates 801 and 802 are made using Polyphenylene Sulfide (PPS), an injectable plastic that has structural integrity comparable to metals. It should be understood that it is further contemplated as within the scope of the invention to use low friction plastics and other materials within the rotatable segment 803 itself, or the top 801 or bottom layer 802 hinge area that the rotatable segment 803 contacts. Friction increases the amount of force needed to rotate the rotatable segments 803. Thus, using frictionless or low friction plastics such as TEFLON, or self-lubricating plastics in either or both the rotatable segment 803 or hinge area reduces the required magnetic flux and consequently increase battery life.

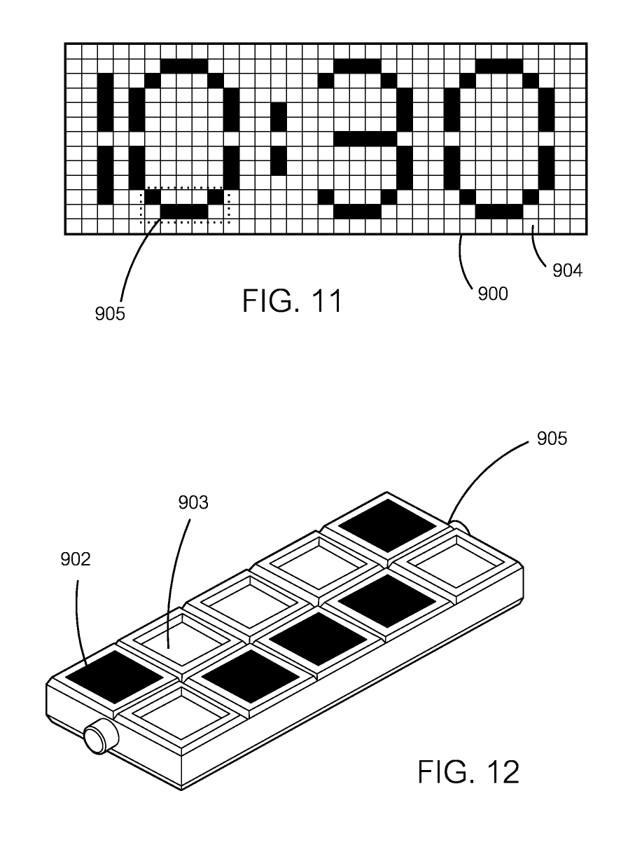

FIGS. 11 and 12 illustrate an embodiment wherein the colors or appearance of materials attached to the rotatable segment (or the rotatable segment itself) in the “ON” optical state may have some portions thereof that contrast and some portions that closely match the appearance of the background of the display. FIG. 11 illustrates a typical time display 900 that has been altered so that the viewer can see that the horizontal segments of the numeric digits are not limited to linear segments. FIG. 11 illustrates the appearance of an “ON” segment in which the segment is not linear in appearance and the dotted box therein shows a single rotatable segment 905 having a length of five panels and a width of two panels (see FIG. 12). FIG. 12 illustrates a magnified view of an exemplary non-linear rotatable segment 905 that would make up a portion of a digit in the “ON” mode. Here you can see that in an “ON” optical state some of the black panels 902 contrast with the background 904, while other white panels 903 on this rotatable segment 905 match the surrounding white background 904. The segment visible to a user when in an “ON” optical state would be a non-linear segment even though the larger five panels long by two panels wide rotatable segment 905 would be rotating.

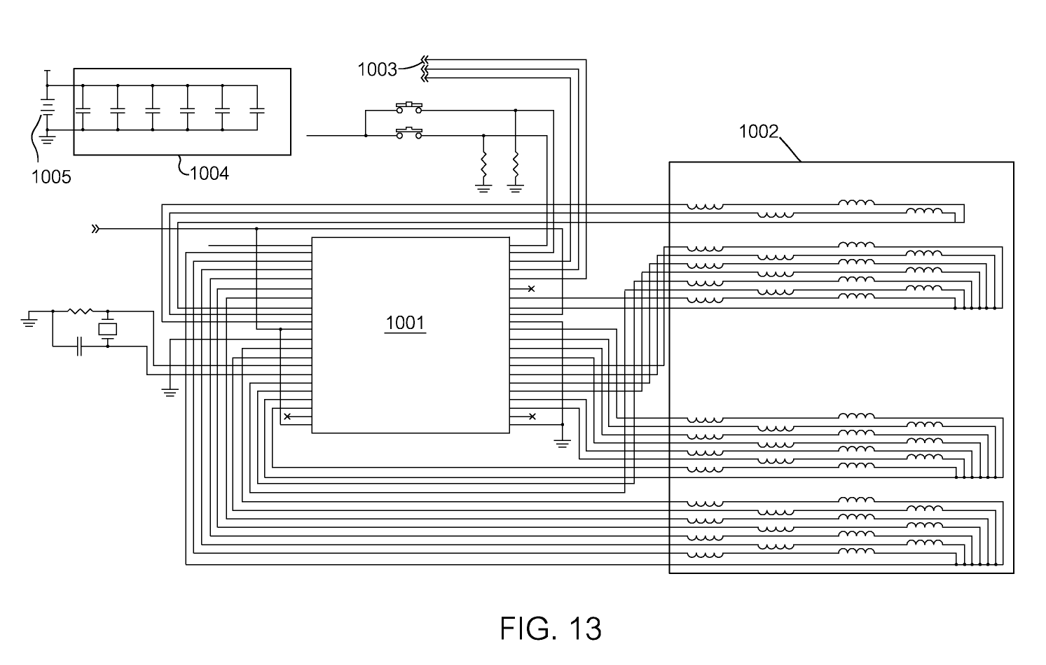

FIG. 13 is a schematic of a driving circuit for rotating the segments in a mobile device such as a watch. The circuit of FIG. 13 illustrates an embodiment in which the MCU (microcontroller unit) 1001 directly drives the coils 1002 that actuate the rotating segments (i.e. without the need for a separate display driver chip). The coils 1002 in FIG. 13 represent a total of 23 respective rotatable segments that would be a typical minimum number used in a watch or clock display that included seven segment digits. Using MCU 1001 to directly drive the coils 1002 to alter orientation of segments reduces cost and power consumption when compared to designs using separate display drivers. In FIG. 13 the MCU 1001 drives the coils 1002 to rotate the respective rotatable segments, which could be done at voltages as low as 3 volts. MCU 1001 drives the coils 1002 that actuate the rotatable segments to produce the desired alphanumeric or graphical representation for information such as chronological time information or a unique graphical appearance. A timer function is preferably present in the MCU 1001 such as the use of an external quartz crystal to keep time. MCU 1001 then drives the appropriate coils 1002 so the respective display information visible depicts the correct time and/or date information.

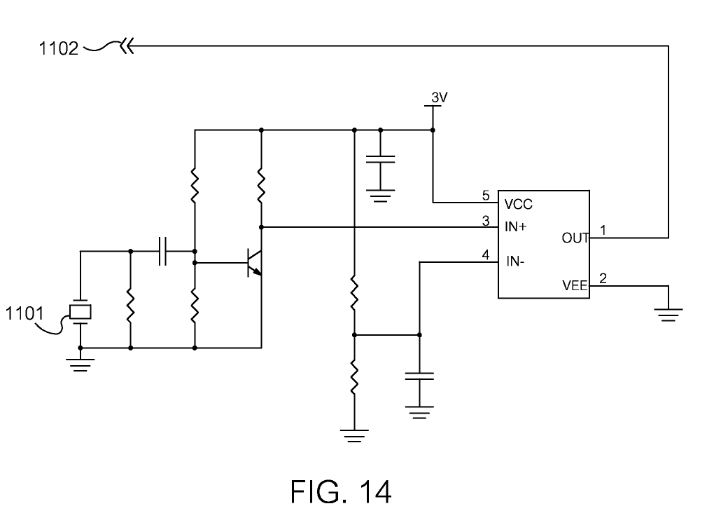

Mobile devices are subject to dropping, vibration, or other forces that might displace one or more rotatable segments from their correct orientation. Additionally, to the extent that errors might arise in driving one or more segments, such should be corrected. However, continuous correction of segment orientation results in large power consumption that can reduce battery lifetime (for example, the lifetime of a standard 3 volt coin cell battery in a watch) to a level well below what consumers will tolerate. The following description of FIGS. 13 and 14 pertain to various features that might be used to address consumer expectations, some of which also provide the possibility of aesthetic improvements to the design of the mobile device. It should be understood that various embodiments of the present invention might include one, some combination of two or more, or all of the features discussed below.

In one embodiment a periodic correction (rather than continuous correction) might be implemented. Such is preferably implemented via software that periodically drives all rotatable segments to insure they are in the correct orientation display (appropriate “ON” or “OFF” optical state). For example, in a watch every hour or every twelve hours the software in the MCU 1001 could apply the correct “ON” or “OFF” driving current and voltage to insure the rotatable segments are all in the correct orientation. Other time intervals are contemplated as within the scope of the invention. Additionally, if desired correction may be triggered whenever a user presses a button to access any watch functions.

In mobile applications such as watches, clocks, or jewelry, the typical coin cell batteries used have limited high current capacity (typically rated at 4 mA-20 mA). At typical voltage and coil 1002 resistances the driving pulse current for just one coil pair 1002 is within that range. Thus, driving multiple coils at the same time likely exceeds battery rating. In another embodiment the coils 1002 for respective rotatable segments are driven by the MCU 1001 sequentially instead of more than one at the same time. This is possible since the driving pulse and response time of the magnetic driven display is rapid. Sequential actuation of the rotatable segments by coils 1002 reduces the likelihood that powering multiple coils 1002 simultaneously adds up above the maximum current that the battery can provide. While exceeding the recommended current capacity is possible, doing so will typically rapidly decrease battery lifetime. In a variation on this embodiment the rotatable segments across the display can be driven sequentially with some pattern. The pattern of reorienting the rotatable segments could be from left to right, right to left, top to bottom, around the perimeter of each alphanumeric character, or randomly. In another variation the sequential pattern is designated by the MCU 1001, or the user may select from among a plurality of pre-programmed patterns that by which the rotatable segments are rotated.

In another embodiment the voltages used to actuate rotation of one or more segments may be in the higher voltage range of 3 to 6 volts. The circuit diagram of FIG. 13 illustrates the voltage signal coming in from a DC-DC converter circuit 1003, to raise the voltage from 3 volts out of the standard coin cell battery up to as much as 6 volts. In various commercial applications the use of a DC-DC converter circuit 1003 to raise the voltage to higher voltage levels can result in more reliable driving of the rotating segments. Furthermore, an equally important function is to insure at least 3 volts even as the battery voltage decreases over its life. Typically a 3 volt coin cell starts at 3 volts but over its lifetime it goes down to 2 volts. At these lower voltages some components such as the MCU 1001 may reset or stop operating. Thus, a voltage signal coming in from a DC-DC converter circuit 1003 helps to insure a minimum voltage level is maintained throughout the lifetime of the battery, rather than a battery lifetime determined by when the voltage drops below 3 volts.

FIG. 13 illustrates yet another feature in the form of including one or more capacitors 1004. Capacitors 1004 are preferably positioned within the circuit with respect to the battery 1005 to reduce or minimize immediate draw upon the battery during magnetic actuation of rotation. That is to say, when it is necessary to drive the rotatable segments, the power required by MCU 1001 to drive the respective coils 1002 is drawn initially from the energy stored in the capacitors 1004. In mobile applications, such as watches, only a small coin cell battery is available. As previously noted, such batteries are typically limited to 4 mA-20 mA before entering a very high current draw state where battery capacity and resulting battery life is reduced. Depending on the amount of energy stored by the capacitors in the circuit 1004, the voltage drop and overall effective drain on the battery 1005 can be reduced and averaged over a longer time. By averaging the current drain over a longer time cycle the negative effects of the short burst of high current drain pulse to drive the coils 1002 should allow the battery to better achieve utilization of its expected battery capacity and resulting lifetime. The preferred system design has one or more capacitors 1004 connected in parallel with the battery 1005 that supply the DC-DC converter 1003. The voltage signal form the DC-DC converter 1003 preferably goes through a switching circuit. The switching circuit selects the proper voltage supply level for the MCU 1001. In normal time-keeping functions the MCU may receive a lower voltage directly from the battery and thereby the system consumes lower current, but when it comes time to drive the coils the MCU is supplied with the higher voltage signal from the DC-DC converter circuit 1003. Various embodiments of the magnetically actuated display technology will preferably rotate a segment in as little as 5-50 msec. Thus, the use of a capacitor 1004 to assist in driving the coils 1002 in a mobile product such as a watch or clock is believed to be minimally detrimental to consumer preferences with respect to any resulting aesthetic impact. A typical time change only occurs once per minute, and in a time display made up of seven segment digits every minute update averages only 4-5 segment transitions. Thus, in one embodiment the capacitor 1004 would store enough energy and have high enough capacitance to drive all of the required segment transitions. However, in a small mobile device, the size and cost required to achieve that several thousand microfarads of capacitance would be challenging. Thus, it is preferable to use a capacitor 1004 in the circuit that would have at least close to or nearly enough energy stored just to drive the respective coil pair 1002 for a single rotatable segment at the necessary voltage, current, and pulse length. The short driving pulse would be followed by a delay of sufficient time for the capacitor 1004 to recharge before driving the next coil pair 1002. Since the display driving time is so small and a per minute update only requires an average of 4-5 segment transitions the additional delay introduced still provides an overall display update in an acceptable period of time. It will be understood that it is contemplated as within the scope of the invention that capacitor 1004 as disclosed for use herein could be a single capacitor, or be several capacitors that are configured in the circuit to add up to the required capacitance. Alternatively, capacitor 1004 could be a supercapacitor or ultracapacitor that can store an unusually high amount of energy.

In a mobile device it can be challenging to increase the holding strength of the magnet so that a rotatable segment does not inadvertently flip if subjected to a shock such as being dropped or front impact. For example, increasing holding strength by increasing magnet strength will also typically increase the current required to “unlock” the rotatable segment and actuate a rotation. Thus, this presents a countervailing consideration given the impact on limited battery life in mobile products. In another embodiment of the invention, rather than increasing the holding strength of the magnet, there will be some means for detecting when shock or vibration or other force might have exceeded the holding strength. In other words, correction of actuation of the plurality of rotatable segments is triggered by force exceeding the preset limit of the means for detecting impact. Such preset limits might be determined, for example, so that a mobile device such as a watch would pass “drop” tests set by various standards. A variety of sensors might be used as the means for detecting including, but not limited to an accelerometer, a mechanical switch, or a piezo shock sensor. When a shock to the mobile device of sufficient magnitude from an impact or drop occurs, the sensor used would provide an indication or signal to the MCU 1001. MCU 1001 would then drive all of the coils 1002 and respective rotatable segments to the correct “ON” and “OFF” optical states. This would insure that a user does not see a rotatable segment in the wrong optical state due to inadvertent rotation due to the shock.

FIG. 14 illustrates the circuit diagram for a shock sensor portion of the circuit of one embodiment. In watch applications the presently preferred means for detecting impact is a piezo shock sensor. A shock sensor 1101, such as a piezo shock sensor, consumes little to no power when not activated. When a shock is applied to the mobile device by dropping, or from an impact, a voltage is produced internally by the shock sensor 1101. Shock sensor then sends a signal pulse 1102 to the MCU 1001 in the circuit. Once a signal pulse 1102 is detected that exceeds a predetermined threshold the MCU 1001 drives all rotatable segments to their correct orientation. In some cases the MCU 1001 may be in a low current or sleep mode. The voltage or indication from the shock sensor 1101 would then awaken MCU 1001, which would then drive all rotatable segments to their correct orientation.

It is understood that the shock sensor utilized could be any number of technologies such as a piezo shock sensor or an accelerometer. The accelerometer used could be an analog version or an integrated chip version of accelerometers that are now common in products such as airbags, preferably with at least 2D or 3D capabilities. An accelerometer often requires more power to stay on and sensing, and therefore may not be ideal for all applications compared to a piezo shock sensor. Another potential solution would be to use a mechanical switch. The mechanical switch would need to be configured within the case of the mobile device in such a way that when a significant force is experienced by the device the mechanical switch closes, resulting in a signal being sent to the MCU. For example, the mechanical switch could be configured in the case on the module with a protrusion within the case aligned with the mechanical switch. When a force is experienced the module could move slightly within the case and the protrusion on the inside of case could then interface and apply force to the mechanical switch thereby closing the circuit. Once the mechanical switch is activated the circuit can be designed so that with the switch closed a signal is sent to MCU to update all rotatable segments to their correct position.

Another embodiment involves backlighting the display with LEDs located underneath the top plane. The crystals, or diamonds affixed to the top plane may have some portion beneath them of the top plane removed or the top plane could be constructed with a transparent material such as plastic. One or more LEDs are positioned underneath the top plate and the light is projected up through the dot matrix elements such as crystals or diamonds located either in the top plate or flippers themselves.

All of the embodiments of this invention illustrated herein feature rotating segments, typically arranged in an array that individually and/or collectively display information in the form of symbols, or alphanumeric characters, but are not limited to these representations. It should be understood that the term segment is broader than the term pixel, the latter having been previously used in describing FIGS. 1-5. The rotatable segment found in any one of the embodiments of this invention could be of a round, elliptical, square, rectangular, triangular, or any other polygonal shape. All various shapes of the rotatable segments are assumed to be utilized especially as differing shapes may be utilized within the array itself so as to be able to impart the desired symbolic, graphical, or alpha-numeric representations collectively. The materials that might be attached to one or more faces of each rotatable segment include, but are not limited to, emeralds, rubies, opals, amethyst, diamonds, or other gems. Other materials that might be attached include, but are not limited to, gold, silver, aluminum, rhinestones, Swarovski crystals, fluorescent or phosphorescent paint glitter, cloth or leather, tritium tubes, hot metal laminates, glass spheres, and plastic laminates that provide a metal, leather, or wood grain appearance.

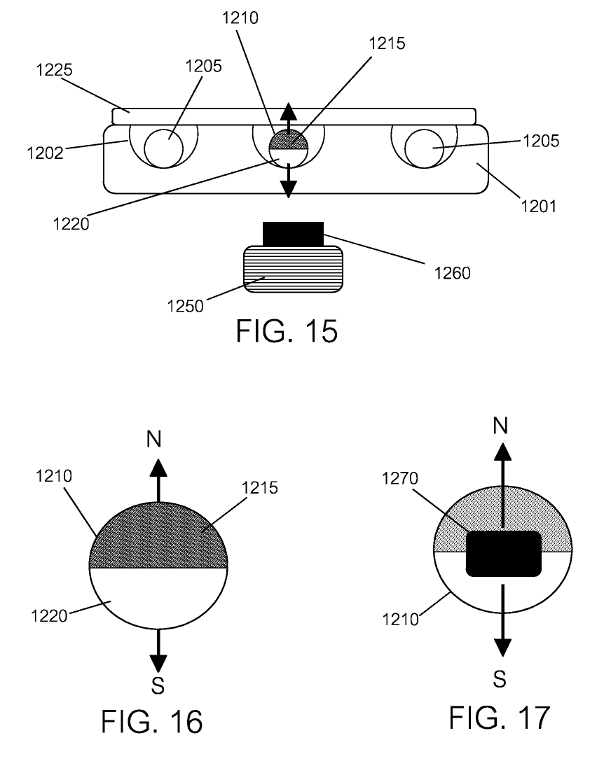

Referring now to FIGS. 15-17, there are illustrated aspects of an embodiment of a magnetically actuated display using “ball” segments. Background 1201 includes a plurality of cavities 1202 that feature a bottom, top, and sides containing the non-rotating segments 1205 and rotating segments 1210. At least some portion of the rotatable segment 1210 includes a permanent magnet. Consequently, when an electromagnetic force is generated, depending on the polarity of the magnetic force generated and the magnet orientation within the rotatable segment 1210, it will rotate to one of two optical states. The active rotatable segment 1210 is preferably bi-hemisphere colored wherein one hemisphere has an appearance that substantially matches the non-rotatable segment 1205 and the background 1201, thereby representing an “OFF” optical state 1220. The other hemisphere of the rotatable segment 1215 has a color, contrast or texture that differs visibly from the neighboring background non-rotatable segment 1205, and represents an “ON” optical state 1215. The orientation of the permanent magnet within or comprising some portion of the rotatable segment 1210 will cause it to rotate to display one of these optical states. In some applications all cavities in the visible display surface might include active rotatable segments 1210. However, in most applications a reduced subset display featuring some inactive segments 1205 is preferable as being less costly and easier to assemble and drive the rotatable segments 1210. The non-rotatable segments 1205 help produce the appearance of a dot matrix background even though inactive. The “OFF” optical state 1220 would be when that hemisphere of the rotatable segment 1205 is oriented toward top surface 1225. It will be understood that the use of some inactive rotatable segments 1205 may be preferable since for some small display sizes it may be too difficult to restrict the magnetic fields, and therefore a more limited number of active rotatable segments 1210 may be able easier to drive between “ON” 1215 and “OFF” 1220 optical states. The non-rotatable segments 1205 might also be secured to some portion of the cavity 1202 such as the bottom so they provide consistent appearance and are not subject to movement or affected by the neighboring magnetic fields.

It should be understood that cavity 1202 could be a portion of a sphere as illustrated in FIG. 15, but could also be oval shaped, rectangular, polygonal (including square), some combination of the foregoing, or some other shape. The shape of the cavities 1202 might be selected to better facilitate the movement of the rotatable segment 1210 when electromagnetically driven, or to reduce its ability to rotate when subject to vibration, shock, or dropping. In one application the cavity 1202 diameter is preferably just slightly larger than the diameter of a spherical or cylindrical rotatable segment 1210, but with enough spacing to allow easy rotation when magnetically actuated. Cavity 1202 and background material 1201 might be constructed by injection molding or extrusion. In various commercial applications under consideration, cavity 1202 and surrounding background material 1201 that may be in contact with the rotatable segment 1210 are constructed out of low friction materials such as Teflon, or self-lubricating plastics. It will be understood that other materials are contemplated as within the scope of the invention. As previously noted, the reduction of friction during rotation will reduce the amount of magnetic force required to rotate a segment and thereby reduce the current consumption and increase battery life. The rotatable segment 1210 itself may also have portions constructed out of lower friction materials as well thereby facilitating easier rotation and lowering the magnetic force required, and therefore lowering current consumption, resulting in longer battery life. Top surface 1225 retains rotating segments 1210 within cavity 1202 during switching and rotation, and will preferably be constructed out of a clear material such as plastic or glass.

As illustrated in FIG. 15, magnetic display has a driving electromagnetic field that is produced by a coil 1250 and core 1260 that are positioned underneath active rotatable segments 1210. In FIG. 15 the coil 1250 and core 1260 have been driven with current so as to produce a north magnetic field emanating out of the top of the coil 1250 and core 1260. Thus, bi-hemisphere colored rotatable segment 1210 has magnetic properties wherein each magnetic pole effectively corresponds to one hemisphere of color. In this example the dark colored hemisphere represents an “ON” optical state 1215 and has a north magnetic field. The lighter colored hemisphere represents an “OFF” optical state 1220 and has a south magnetic field, which is attracted to the north magnetic field emanating from the coil 1250 and core 1260. The display in this state presents an optical state of a dark hemisphere visible representing an “ON” optical state 1215 to a user that contrasts visibly from the neighboring light colored non-rotatable segments 1205 in this example. The rotatable segment 1210 can be rotated 180 degrees by application of current in the opposite direction through the coil 1250 so that a south magnetic field emanates out of the top surface. The south magnetic field would cause a repulsion of the rotating segment 1210 magnetic field currently facing the coil 1250 and core 1260 resulting in a rotation to a new “OFF” optical state 1205.

It will be understood that additional magnetic shielding materials or additives may be incorporated within the background substrate 1201. This magnetic shielding material may be used within the background material 1201, and preferably exists within the gap region between each cavity. Magnetic shielding materials are quite common and any number of the available materials and future materials could be used, or made into an additive placed in the plastic or material from which the background is manufactured. The purpose of the magnetic shielding is to reduce the magnetic field emanating from the coil 1250 and core 1260 material beneath the rotatable segments 1210 when neighboring active rotatable segments 1210 need to be driven independently. In other applications it may be preferable to drive multiple rotating segments 1210 using the same coil 1250 and core 1260. In these applications a material such as steel or other magnetic conductive materials might instead be used to extend the magnetic field from one or more active coil 1250 and core 1260 electromagnetic actuator assemblies (i.e. to extend the area of the magnetic field produced to actuate more than one rotatable segment 1210).

The driving underlying magnetic actuation system might include a core 1260 that is U-shaped with at least one but possibly two coils 1250 connected in series on its armatures. The driving coil 1250 may utilize a pair of coils 150 connected in series or a single coil 1250 as illustrated in FIG. 15 affixed to the post or U-shaped core 1260. When driving a display that has only selected regions with rotatable segments 1210, one portion of the U-shaped core 1260 could be positioned under the neighboring non-magnetic and non-rotating segment 1205. U-shaped core 1260 helps close the magnetic circuit insuring that the magnetic field used to actuate a rotatable segment 1205 does not emanate in all directions out of the top and bottom of a coil 1250 and core 1260 post like construction, but is directed away from neighboring rotatable magnetic segments 1210. The underlying driving mechanism of coils 1250 and cores 1260 are preferably integrated on a bobbin and/or printed circuit board such as that illustrated in FIGS. 8 and 9.

FIGS. 16 and 17 illustrate various aspects of the rotatable segment 1210. Segment 1210 is constructed at least in part, and preferably entirely, out of some permanent magnetic material. Examples of such a permanent magnetic material include, but are not limited to, rubber ferrite, ferrite, neodymium, or another magnetic material or combination of magnetic material with rubber or injection moldable material. In FIG. 16 the magnetic rotatable segment 1210 has a round or oval shape. Segment 1210 is bi-colored so that one hemisphere corresponds approximately to the magnetic polarity emanating out of the permanent magnet rotatable segment 1210. In this example a south magnetic field emanates out of the white colored hemisphere 1220, and a north magnetic field emanates out of the dark colored hemisphere 1215. FIG. 17 illustrates another preferred embodiment wherein a smaller permanent magnetic material 1270 is integrated within the rotatable segment 1210. The magnetic fields emanating out of the encased permanent magnet 1270 also preferably align with the colored hemispheres of the rotatable segment 1210. In some applications various multi-pole magnetizations may provide unique advantages versus the single north and south magnetic poles illustrated.

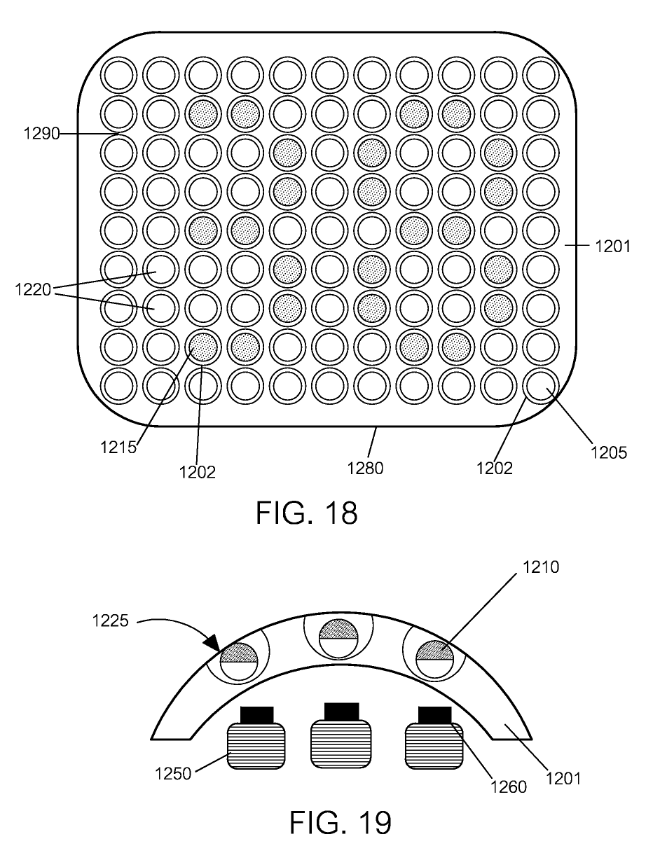

FIG. 18 illustrates features from the viewer's perspective of a numeric display 1280 using rotatable “ball” segments 1210 that may be round, or oval or similar shaped smooth or faceted beads. Thus, it will be understood that the term “ball” segment as used herein is not limited to purely spherical or round shapes, but encompasses the other shapes described herein. The term “ball” segment encompasses such shapes as can be rotated within a cavity without the need for a hinge as is necessary for flat rectangular panels. Such an embodiment with a round or oval shaped segment does not require the hinge or similar mechanism present in previously discussed embodiments. The rotatable segments 1210 have permanent magnetic fields as they may be made of a magnetic material including, but not limited to ferrite, ceramic, neodymium, or some rubber ferrite or magnetic thermoplastic or combination thereof. Alternatively, as previously described with respect to FIG. 17, the rotatable segment 1210 might include a permanent magnet 1270 therein. Regardless, the magnetic field emanating from the rotatable segment 1210 is oriented so that the north magnetic field emanates out of one of the colored hemispheres of the bi-colored rotating segment 1210 and the south magnetic field emanates out of the differently colored hemisphere. In FIG. 18 one side of the bi-colored rotatable segment 1210 has one hemisphere that is colored dark grey that denotes a visible “ON” segment 1215 as it contrasts to the white “OFF” bi-colored hemisphere 1220 of the rotatable segments. Similarly, the non-rotating segments 1205 are also colored white, the segments 1205 and 1210 together creating the appearance of dot matrix numeric display 1280.

FIG. 18 also illustrates a gap 1290 present between adjacent cavities 1202 that is part of the visual background 1201 around the respective rotating 1210 and non-rotating segments 1205. This gap 1290 distance can be smaller than the gap necessarily present in the magnetic displays disclosed in the previously incorporated by reference U.S. application Ser. No. 11/004,398 to Brewer et al. entitled “Magnetic Display For Watches” that was filed on 27 Sep. 2007. Since there are no hinges or bearing points of contact required in this embodiment, the gap 1290 between cavities 1202 can theoretically be as small as one can produce using extrusion of a multi-hole honeycomb structure or injection molding (typically in the range of 0.05 mm to 0.5 mm). Similarly, any color of material or texture can be used in the background 1201 and visible in the gap 1290. That is to say, the display in FIG. 18 has no material seams as exist between flippers and surrounding background in the incorporated by reference application. Therefore the background 1201 between cavities 1202 containing rotatable 1210 and non-rotatable segments 1205 can have any color, material, or texture. This can be used as desired to improve the overall variance and consumer appeal, as not only can the colors used in the rotating 1210 and non rotating segments 1205 be varied, but the surrounding and visible background material 1201 is not limited to just dark colors or black to hide material gaps. There are endless colors, and types of beads commonly used in jewelry that include glass, ceramic, plastic, or precious materials such as diamonds, gemstones, metals such as gold or silver and many other bead materials. The rotatable segment 1210 as illustrated in FIG. 18 could consist of any of these bead materials, colors, or textures.

FIG. 19 illustrates various aspects of a shaped, non-flat display. A curved display surface is produced by the background 1201 containing cavities 1202. The underlying coils 1250 and cores 1260 driving each rotatable segment 1210 could be on a flat plane as shown. Coils 1250 and cores 1260 could also feature varying height or size to keep the same relative distance and magnetic field strength produced for each rotatable active segment, or they could be mounted on a flexible PCB. Similar to other embodiments discussed herein, the coils 1250 and cores 1260 used to drive each respective rotatable segment 1210 are preferably mounted on a flexible PCB that would follow the same curve as the outer display surface 1225. This preferred embodiment includes display surfaces 1225 that may be curved, angled, or any assortment of shapes or even faceted.

It will be understood that the rotatable segment 1210 may be a conventional bead material that has some portion therein of a permanent magnetic material. The rotatable segment 1210 preferably is a round bead shaped material that has differing color, texture, appearance, or material on each of two hemispheres approximately aligned with the magnetic fields. The magnetic rotatable segment 1210 is preferably attracted to the underlying core 1260 and coil 1250 assembly and helps retain it in place when no current is passing through and driving the system. The round or bead like shape might not provide sufficient means to prevent rotation when the display system 1290 is subjected to vibration or drop. In such a scenario, the rotating segments 1210 preferably include one or more facets, the facets providing a flatter contact surface. A conventional round or pearl like bead structure was illustrated in FIGS. 15-17. However, it will be understood that it is contemplated as within the scope of the invention that the rotatable segment 1210, instead of being spherical, could take on other shapes that include, but are not limited to, a bi-cone faceted bead, a round bead that has a number of facets, or even a cube shaped bead. Such facets provide a resting surface on the bottom of the cavity versus just a point of contact that would theoretically exist when using a rotatable segment bead that is perfectly spherical. A more flat resting surface or facet located in the position when the rotatable segment 1210 is oriented in one of the two optical states would reduce ease of rotation when the display 1290 is subjected to vibration or drop. For those very unique bead shapes such as bi-cone, or even a cube, the corresponding cavity might take on any type of shape as long as it provides enough space so that the associated rotating segment is able to rotate between the two optical states.

The display 1290 utilizing rotatable segments 1210 as taught herein could use the same driving electronics as those previously discussed. The display preferably will utilize a MCU capable of directly driving the coils in combination with other supporting electronics that might include a voltage converter as well as means for detecting force such as a piezo shock sensor or accelerometer circuit that could detect vibration or shock that might cause rotatable segments 1210 to be displaced from the desired orientation. The underlying coils 1250 and cores 1260 used to drive the rotatable segments 1210 are preferably integrated into the printed circuit board. Additional adhesives and/or epoxies are preferably used to secure and protect brittle core materials that may be used in this type of display 1290. Also for mobile display applications such as watches, clocks, or mobile phones the rotatable segments 1210 are preferably driven sequentially.

As used herein the term U-shaped broadly encompasses U-shaped, C-shaped and other embodiments generally having a base portion that connects two arms. The connection between each arm and the base portion may be perpendicular or may be, curved. The base portion itself is not necessarily straight and may be curved if desired.

All of the coils illustrated in the figures show a relatively round or elliptical shape. It will be recognized that the final shape, number of turns of coil, thickness of wire or type of wire used in producing the coils, are all able to be customized and varied to produce the desired magnetic field force as well as shape of the produced magnetic field. Any and all possible variations for the shape, location of first permanent magnet, and design of the rotatable segments as well as the underlying actuation coils are contemplated as within the scope of the present invention. Small mobile applications of the various embodiments of rotatable segments include, but are not limited to, a watch, cell phone, jewelry, or clock display. Applications in watches will be understood to further include embodiments in which a magnetic display with rotating segments is used in a watch in combination with an analog watch movement.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A watch display, comprising:
a plurality of rotatable segments and a background, wherein each segment includes a magnetic material extending across its width, and wherein each segment is rotatable between at least two optical states; and
a plurality of magnetic actuators positioned beneath the plurality of segments to rotate the segments between the at least two optical states, each magnetic actuator including a U-shaped core having two arms with coils thereon and having a top defined by a pair of ends of the two arms, wherein the top is substantially parallel or below a plane defined along the width of the magnetic material of the corresponding segment, and wherein the top at the two arms extends toward the magnetic material of the segment.

2. The watch display of claim 1, further comprising a microcontroller for controlling rotation of the plurality of segments that is connected to the plurality of magnetic actuators.

3. The watch display of claim 2, wherein the microcontroller is programmed to sequentially rotate the plurality of segments.

4. The watch display of claim 3, further comprising a battery electrically connected to the microcontroller, wherein the microcontroller directly drives the coils of each magnetic actuator.

5. The watch display of claim 4, wherein the magnetic actuators are integrated onto a printed circuit board, and further including an adhesive around the cores.

6. The watch display of claim 5, further comprising means for detecting impact that is connected to the microcontroller, the microcontroller being programmed to rotate each segment to a correct optical state when an impact exceeding a preset limit is detected.

7. The watch display of claim 2, further comprising a capacitor electrically connected in parallel with the battery that supply a DC-DC voltage converter.

8. (canceled)

9. A timepiece display module, comprising:
a display having a plurality of rotatable segments that provide chronological or graphical information, each rotatable segment including a magnetic portion and rotating between a first orientation having a first optical state and a second orientation having a second optical state that is different from the first optical state, and wherein at least some of the segments are adjacent to a background that substantially matches one of the first optical state and the second optical state; and
a battery electrically connected to means for sequentially magnetically rotating the plurality of rotatable segments.

10. The timepiece display module of claim 9, wherein the means for sequentially magnetically rotating the plurality of rotatable segments includes a microcontroller for controlling rotation of the plurality of segments that is connected to a plurality of magnetic actuators, and wherein the microcontroller is electrically connected to the battery.

11-12. (canceled)

13. The timepiece display module of claim 10, further comprising means for detecting impact that is connected to the microcontroller, the microcontroller being programmed to rotate each segment to a correct optical state when an impact exceeding a preset limit is detected.

14. The timepiece display module of claim 13, wherein the means for detecting impact is a piezo shock sensor.

15. The timepiece display module of claim 10, further comprising a capacitor electrically connected to the microcontroller in parallel to the battery.

16. (canceled)

17. The timepiece display module of claim 10, wherein the segments include a simulated dot matrix pattern.

18. The timepiece display module of claim 10, further including at least one analog hand.

19-20. (canceled)

21. A watch flip dot display, comprising:
a plurality of magnetic actuators that rotate a plurality of at least partially magnetic rotatable segments that collectively represent at least one alphanumeric digit in a background when oriented at one of a first rotational position and a second rotational position, wherein the plurality of magnetic actuators are sequentially directly driven by a microcontroller that is electrically connected to a battery.

22-25. (canceled)

26. The watch flip dot display of claim 21, wherein at least one of the rotatable segments comprises at least two simulated dot matrix panels.

27-34. (canceled)

35. The watch flip dot display of claim 21, further comprising means for detecting impact that is connected to the microcontroller, the microcontroller being programmed to rotate each segment to a correct rotational position when an impact exceeding a preset limit is detected.

36-37. (canceled)

38. The watch flip dot display of claim 21, further including at least one analog hand positioned above the rotatable segments and the background.

39. A watch, comprising:
a display including a plurality of rotatable segments that collectively provide chronological information in a background, each rotatable segment including a magnetic portion and rotating between a first orientation to present a first display face with a first optical state and a second orientation to present a second display face having a second optical state, the first optical state being different from the second optical state, and wherein one of the first optical state or the second optical state substantially matches the background;
means for magnetically rotating the plurality of rotatable segments;
a microcontroller that directly drives the means for magnetically rotating the plurality of rotatable segments; and
a battery electrically connected to the microcontroller.

40-41. (canceled)

42. The watch of claim 39, wherein at least some of the segments include a plurality of simulated dot matrix panels.

43-44. (canceled)

45. The watch of claim 42, further comprising means for detecting impact that is connected to the microcontroller, the microcontroller being programmed to rotate each segment to a correct optical state when an impact exceeding a preset limit is detected.

46. The watch of claim 45, wherein the microcontroller is programmed to sequentially rotate the plurality of segments.

47. The watch of claim 39, further comprising means for detecting impact that is connected to the microcontroller, the microcontroller being programmed to rotate each segment to a correct optical state when an impact exceeding a preset limit is detected.

48. The watch display of claim 47, further comprising a capacitor electrically connected in parallel with the battery that supply a DC-DC voltage converter.

49-50. (canceled)

51. A mobile device, comprising:
a display having a plurality of rotatable segments that provide chronological or graphical information in a background, each rotatable segment including a magnetic portion and rotating between a first orientation having a first optical state and a second orientation having a second optical state that is different from the first optical state, and wherein the background has an optical characteristic that substantially matches one of the first optical state and the second optical state of a majority of the segments;
a microcontroller electrically connected to a plurality of magnetic actuators positioned beneath the plurality of rotatable segments, wherein the microcontroller is programmed to rotate each segment to a correct optical state when an impact exceeding a preset limit is detected by means for detecting impact that is connected to the microcontroller; and
a battery electrically connected to the microcontroller.

52. The mobile device of claim 51, wherein the mobile device is selected from the group consisting of a watch, clock, jewelry, cell phone, and carrying case for a cell phone or MP3 player.

53-61. (canceled)

62. A watch comprising:
a plurality of rotatable segments that provide at least one of chronological or graphical information in a background, each rotatable segment including a magnetic portion and rotating between a first orientation having a first optical state and a second orientation having a second optical state, and wherein the background substantially matches one of the first optical state and the second optical state; and
means for magnetically rotating the plurality of rotatable segments, wherein the means for magnetically rotating is controlled by a microcontroller that is electrically connected in parallel to a coin cell battery and a capacitor.

63. The watch of claim 62, wherein the microcontroller is programmed to sequentially rotate the plurality of segments.

64. The watch of claim 63, wherein the microcontroller directly drives the means for magnetically rotating.

65. The watch of claim 63, further comprising means for detecting impact that is connected to the microcontroller, the microcontroller being programmed to rotate each segment to a correct optical state when an impact exceeding a preset limit is detected.

66-85. (canceled)
